(19) United States
(12) Patent Application Publication
(10) Pub. No.: US 2008/0241703 A1
(43) Pub. Date: Oct. 2, 2008

(54) Nonaqueous electrolyte secondary battery

(76) Inventors: Hidekazu Yamamoto, Moriguchi-city (JP); Yasuo Takano, Moriguchi-city (JP); Takanobu Chiga, Moriguchi-city (JP); Atsushi Fukui, Moriguchi-city (JP); Taizou Sunano, Moriguchi-city (JP); Maruo Kamino, Moriguchi-city (JP)

Correspondence Address: KUBOVCIK & KUBOVCIK, SUITE 1105, 1215 SOUTH CLARK STREET, ARLINGTON, VA, 22202, US

(21) Appl. No.: 12/078,052

(22) Filed: Mar. 26, 2008

(30) Foreign Application Priority Data
Mar. 28, 2007 (JP) 2007-084494
Sep. 25, 2007 (JP) 2007-246571

(51) Int. Cl. H01M 10/26; H01M 4/58

(52) U.S. Cl. 429/338; 429/220

(57) ABSTRACT

A nonaqueous electrolyte secondary battery which includes a positive electrode, a negative electrode and a separator stacked and wound in a cylindrical configuration, and which achieves a high energy density and superior cycle performance characteristics.

The nonaqueous electrolyte secondary battery includes a positive electrode containing a positive active material, a negative electrode containing a negative active material, a separator interposed between the positive electrode and the negative electrode, and a nonaqueous electrolyte containing a solvent and a solute. Those positive electrode, negative electrode and separator are stacked and wound in a cylindrical configuration. Characteristically, the negative active material comprises a material that stores lithium via alloying with lithium, the solvent in the nonaqueous electrolyte contains a fluorinated cyclic carbonate, and the nonaqueous electrolyte has a viscosity of not higher than 2.5 mPas.

### BACKGROUND OF THE INVENTION

1. Technical Field

The present invention relates to a nonaqueous electrolyte secondary battery in which a positive electrode, a negative electrode and a separator are stacked and wound in a cylindrical configuration.

2. Background Art

Recent years have seen the rapid progress of reduction in size and weight of mobile devices such as mobile telephones, notebook personal computers and PDA. Also, the increase in function thereof pushes up power consumption. These have led to an increasing demand for a nonaqueous electrolyte secondary battery, for use as a power source, which has further reduced weight and increased capacity. Currently, graphite and other carbon materials are used for a negative electrode of lithium secondary batteries. However, graphite material has been used up to an upper limit (372 mAh/g) of its theoretical capacity and is becoming difficult to meet a future high capacity demand.

In order to meet the demand, a negative electrode comprised of an alloy such as of silicon, germanium or tin has been recently proposed which exhibits an improved charge-discharge capacity, either gravimetric or volumetric, compared to carbon-based negative electrodes. The use of these negative electrode materials increases an energy density of a lithium secondary battery. Particularly, silicon is a promising negative electrode material for its high theoretical capacity, about 4,000 mAh per gram of active material.

Such a material as silicon stores lithium and increases its volume by alloying with lithium. Accordingly, in the case where a material which stores lithium via alloying with lithium is used as a negative active material, expansion and shrinkage of the active material occur with charge and discharge. Hence, problematic cracking or separation of the negative active material from a current collector occurs when a charge-discharge cycle is repeated, resulting in the deterioration of a charge-discharge cycle performance. In an effort to suppress such deterioration of charge-discharge cycle performance, various electrode structures have been proposed (see, for example, Japanese Patent Laid-Open Nos. Hei 10-255768 and 2001-266851).

In the case where a battery uses, as the negative active material, the material which stores lithium by alloying with lithium, if an electrode assembly is constructed in a wound and flattened configuration, deformation along the direction in which the electrode assembly is wound occurs as the alloy material expands and shrinks during charges and discharges. However, if the electrode assembly has a cylindrical wound configuration, it becomes more likely that a force due to expansion of the negative electrode is directed toward an inside of the electrode assembly to force the electrolyte retained therein to exit from the electrode assembly and accordingly cause electrolyte depletion in the electrode assembly. Then, the electrolyte present in the battery becomes insufficient and a charge-discharge reaction becomes heterogeneous. In this case, marked swelling of the negative electrode occurs and causes further release of the electrolyte from the electrode assembly, which renders the battery more susceptible to deterioration and leads to problematic deterioration of cycle performance characteristics.

### SUMMARY OF THE INVENTION

It is an object of the present invention to provide a nonaqueous electrolyte secondary battery which is constructed in a cylindrical wound configuration, which uses, as a negative active material, a material that stores lithium by alloying with lithium, and which shows a high energy density and superior cycle performance characteristics.

The present invention is concerned with a nonaqueous electrolyte secondary battery which includes a positive electrode containing a positive active material, a negative electrode containing a negative active material, a separator interposed between the positive and negative electrodes and a nonaqueous electrolyte containing a solvent and a solute, and in which the positive electrode, the negative electrode and the separator are stacked and wound in a cylindrical configuration. Characteristically, the negative active material comprises a material which stores lithium by alloying with lithium, the solvent in the nonaqueous electrolyte contains a fluorinated cyclic carbonate and the nonaqueous electrolyte has a viscosity of not higher than 2.5 mPas.

In the case where a nonaqueous electrolyte secondary battery uses, as a negative active material, a material that stores lithium by alloying with lithium and includes a positive electrode, a negative electrode and a separator which are stacked and wound in a cylindrical configuration, as described above, the occurrence of marked expansion and shrinkage during charges and discharges forces release of the electrolyte from the electrode assembly and accordingly increases the occurrence of electrolyte depletion in the electrode assembly. The use of the nonaqueous electrolyte having a viscosity of not higher than 2.5 mPas, in accordance with the present invention, eases another penetration of the electrolyte once released during charges and discharges into the electrode assembly.

Also in the present invention, the nonaqueous electrolyte contains a fluorinated cyclic carbonate, as a solvent. This fluorinated cyclic carbonate forms a film on a surface of the negative active material, which suppresses decomposition of the electrolyte in the neighborhood of an electrode interface. It also suppresses deterioration due to expansion of the negative active material and thus restrains release of the electrolyte from the electrode assembly. Therefore, charge-discharge cycle performance characteristics can be further improved.

In the present invention, a chain carboxylate ester represented by R₁COOR₂ (R₁ and R₂ are independently an alkyl having a carbon number of 3 or less) is preferably contained as a solvent. Because such a chain carboxylate ester is a low-viscosity solvent, the inclusion of this solvent lowers a viscosity of the nonaqueous electrolyte and makes it easy for the electrolyte once released during charges and discharges to again penetrate into the electrode assembly.

Examples of chain carboxylate esters include methyl acetate (CH₃COOCH₃), ethyl acetate (CH₃COOCH₃), n-propyl acetate (CH₃COOCH₂CH₂CH₃), i-propyl acetate (CH₃COOCH(CH₃)CH₃), methyl propionate (C₂H₅COOCH₃), ethyl propionate (C₂H₅COOC₂H₅), n-propyl propionate (C₂H₅COOCH₂CH₂CH₃), i-propyl propionate (C₂H₅COOCH(CH₃)CH₃), methyl n-butyrate (CH₃CH₂CH₂COOCH₃), ethyl n-butyrate (CH₃CH₂CH₂COOC₂H₅), n-propyl n-butyrate (CH₃CH₂CH₂COOCH₂CH₂CH₃), i-propyl n-butyrate (CH₃CH₂CH₂COOCH(CH₃)CH₃), methyl i-butyrate (CH₃ (CH₃)CHCOOCH₃), ethyl i-butyrate (CH₃(CH₃)CHCOOC₂H₅), n-propyl i-butyrate (CH₃(CH₃)CHCOOCH₂CH₂CH₃) and i-propyl i-butyrate (CH₃(CH₃)CHCOOCH(CH₃)CH₃).

For the purpose of obtaining particularly good cycle performance characteristics, the use of a chain carboxylate ester having a carbon number of 5 or less is preferred. More specifically, methyl acetate (CH₃COOCH₃), ethyl acetate (CH₃COOCH₃), n-propyl acetate (CH₃COOCH₂CH₂CH₃), i-propyl acetate (CH₃COOCH(CH₃)CH₃), methyl propionate (C₂H₅COOCH₃), ethyl propionate (C₂H₅COOC₂H₅), methyl n-butyrate (CH₃CH₂CH₂COOCH₃) and methyl i-butyrate (CH₃(CH₃)CHCOOCH₃) are preferably used. Particularly preferred among them are methyl acetate (CH₃COOCH₃), ethyl acetate (CH₃COOCH₃) and methyl propionate (C₂H₅COOCH₃) which are lower in viscosity.

In consideration of high-temperature performance of the battery, methyl propionate is particularly preferred for its relatively high boiling point.

Examples of fluorinated cyclic carbonates useful in the present invention include 4-fluoro-1,3-dioxolane-2-one, 4,5-difluoro-1,3-dioxolane-2-one (inclusive of optical isomers), 4,4-difluoro-1,3-dioxolane-2-one and 4-fluoro-5-methyl-1,3-dioxolane-2-one.

The use of at least one of 4-fluoro-1,3-dioxolane-2-one and 4,5-difluoro-1,3-dioxolane-2-one (inclusive of optical isomers), among them, as the fluorinated cyclic carbonate is more preferred. Because 4-fluoro-1,3-dioxolane-2-one is electrochemically stable, the use thereof results in obtaining particularly good performance characteristics.

Also, it is particularly preferred that 4-fluoro-1,3-dioxolane-2-one (FEC) and 4,5-difluoro-1,3-dioxolane-2-one (DFEC) are both used as the fluorinated cyclic carbonate. This is probably because FEC, if used in combination with DFEC that is more susceptible to reduction than FEC, provides a dense film on a surface of a negative electrode and accordingly improves cycle characteristics over a prolonged period of time.

Also, it is particularly preferred that DFEC is in the trans form. This is because the trans-DFEC is lower in viscosity than the cis-DFEC and thus lowers a viscosity of the nonaqueous electrolyte.

The fluorinated cyclic carbonate is preferably contained in the range of 5-40% by volume, based on the total amount of the solvent. Also, the chain carboxylate ester content is preferably controlled such that the viscosity of the nonaqueous electrolyte does not exceed 2.5 mPas, more preferably 2.0 mPas. The chain carboxylate ester content is further preferably 70% by volume or more, based on the total amount of the solvent.

The negative active material in the present invention is a material which stores lithium via alloying with lithium. A silicon-containing material is preferably used as such material. The silicon-containing material can be illustrated by silicon and a silicon alloy. The silicon alloy preferably contains silicon in the amount of at least 50% by weight.

The negative electrode using the silicon-containing material as the negative active material can be fabricated, for example, by depositing a thin film of active material containing silicon and/or a silicon alloy onto a current collector. The thin film of active material can be deposited from a vapor or liquid phase. Deposition of the thin film from a vapor phase can be accomplished by such methods as CVD, sputtering, vapor deposition and thermal spraying. Particularly preferred among them are CVD, sputtering and vapor deposition. Deposition of the thin film from a liquid phase can be accomplished by a plating method such as electrolytic or electroless plating.

The current collector on which the thin film of active material is deposited is preferably roughened at its surface. A surface roughness Ra of the current collector is preferably 0.01 μm or larger, more preferably 0.2 μm or larger, but not larger than 1 μm. The surface roughness Ra is specified in Japanese Industrial Standards (JIS B 0601-1994) and can be measured as by a surface roughness meter.

Irregularities may be formed on the current collector. Then, those which conform in shape to the irregularities on the current collector can be imparted to a surface of the active material thin film when deposited onto the current collector. This more likely results in the formation of low-density regions in the thin film that extend from valleys of the irregularities on the current collector to the corresponding ones on the thin film. During charges and discharges, the thin film of active material expands and shrinks as it stores and releases lithium. By such expansion and shrinkage, gaps are formed in the thin film along the low-density regions. These gaps extending in a thickness direction of the thin film divide the thin film into columns. In the present invention, it is preferred that the thin film of active material is divided into columns by the gaps formed in its thickness direction and such columns have bottom portions closely adhered to the current collector.

Such structure eases penetration of the electrolyte into the thin film of active material through its column surfaces. If penetration of the electrolyte is eased, a charge-discharge reaction occurs more homogeneously in the active material. As a result, deterioration of the active material can be retarded. In particular, the nonaqueous electrolyte for use in the present invention is very low in viscosity. Therefore, such a columnar structure provides a greater effect from the viewpoint of electrolyte penetration.

Also, a constituent of the current collector is preferably diffused into the thin film of active material. Such diffusion of the current collector constituent improves adhesion of the current collector to the bottom portions of columns of the thin film of active material. Further, the diffusion of the current collector constituent into the bottom portions of columns suppresses expansion and shrinkage of those bottom portions of columns during charge and discharge and accordingly restrains separation thereof from the current collector.

The thin film of active material can be illustrated by a microcrystalline silicon thin film and an amorphous silicon thin film. Another example is a thin film of a silicon alloy containing cobalt and/or others.

The negative electrode in the present invention may be fabricated by applying, in the form of a layer, an anode mix containing a particulate active material containing silicon and/or a silicon alloy and a binder onto a surface of the current collector, and then sintering the applied anode mix layer under non-oxidizing atmosphere, for example. Examples of silicon alloys include solid solutions of silicon and at least one other element, intermetallic compounds of silicon and at least one other element, and eutectic alloys of silicon and at least one other element. Alloys can be produced by various methods including arc melting, liquid quenching, mechanical alloying, sputtering, chemical vapor growth and firing. In particular, the liquid quenching method encompasses single roller quenching, twin roller quenching, and various atomizing methods such as gas atomizing, water atomizing and disc atomizing. Also in the present invention, silicon particles alone can be suitably used as the particulate active material.

The binder may preferably comprise polyimide. Because polyimide exhibits superior heat resistance and high bonding strength, it effectively restrains separation of the active material from the current collector even if the active material expands and shrinks.

The anode mix layer is sintered on a surface of the current collector under the non-oxidizing atmosphere. For example, such sintering can be carried out under vacuum, under nitrogen atmosphere or under argon or other inert gas atmosphere. Sintering may also be carried out under hydrogen or other reducing atmosphere. Preferably, a heat treatment temperature on sintering does not exceed melting points of the current collector and the particulate active material. Specifically, the heat treatment temperature may preferably be in the range of 200-500° C., more preferably in the range of 300-450° C. If the heat treatment is carried out at a temperature that is equal to or higher than a melting point or glass transition temperature of the binder, adhesion between the particulate negative active material and the current collector can be further improved. Preferably, the heat treatment is carried out at a temperature that is lower than a thermal decomposition temperature of the binder. In the case where polyimide is used as the binder, the heat treatment is preferably carried out at a temperature in the range of 300-450° C. A spark plasma sintering or negative electrode hot pressing technique may be utilized to accomplish the sintering.

The current collector preferably comprises a conductive metal foil, as similar to the case of the above-described negative electrode using the thin film as the active material. The current collector preferably has a roughened surface. In particular, a surface portion of the current collector that carries the anode mix layer thereon preferably has a surface roughness Ra of at least 0.2 μm. The use of a conductive metal foil having such a surface roughness Ra as the current collector enlarges a contact area between the particulate active material and the current collector surface so that sintering occurs effectively under the non-reducing atmosphere. As a result, the adhesion of the particulate active material to the current collector can be improved. Further, the binder is allowed to penetrate into recesses on a surface of the current collector. Then, an anchor effect is created between the binder and the current collector to further improve adhesion. As a result, separation of the anode mix layer from the current collector is further restrained, even if the particulate active material expands and shrinks as it stores and releases lithium. In the case where the active material layer is provided on both sides of the current collector, each side of the current collector preferably has a surface roughness Ra of at least 0.2 μm.

After deposition of the anode mix layer on the current collector, they are preferably rolled or calendered together before being sintered. Such calendering increases a packing density in the anode mix layer and thereby enhances adhesion both between the active material particles and between the active material particles and the current collector.

The negative electrode fabricated in the preceding fashion enjoys high adhesion between the particulate active material and the current collector, which increases the difficulty of the particulate active material to fall off from the current collector. This effectively minimizes expansion of the negative electrode and suppresses release of the electrolyte from the electrode assembly. As a result, improved cycle performance characteristics can be obtained.

The positive active material for use in the present invention is not particularly specified. Any positive active material can be used, so long as it is applicable for nonaqueous electrolyte secondary batteries. Examples of useful positive active materials include lithium transition metal oxides such as LiCoO₂, LiMn_{1/3}Ni_{1/3}Co_{1/3}O₂, LiMn₂O₄ and LiNiO₂. These oxides can be used alone or in combination.

In the case where LiCoO₂ (lithium cobaltate) is used as the positive active material, the positive active material layer containing the positive active material, binder and electrical conductor preferably has a packing density of not less than 3.7 g/cm³. The action and effect of the present invention become further remarkable when the packing density is not less than 3.7 g/cm³. That is, although an increasing packing density generally slows penetration of the electrolyte and accordingly lowers an energy density and deteriorates cycle characteristics, the present invention assures a high energy density and good cycle characteristics even in such a case. An upper limit of the packing density is not particularly specified but may generally be not greater than 3.85 g/cm³.

In the case of using lithium cobaltate, Zr is preferably added to lithium cobaltate. Addition of Zr suppresses the tendency of lithium cobaltate toward crystal collapse when a positive electrode potential goes higher. Zr is preferably added in the range of 0.1-3.0% by mole, based on the total amount of metal elements, other than lithium, present in lithium cobaltate. Also, Mg may be further added to lithium cobaltate. Addition of Mg results in obtaining more stable charge-discharge cycle characteristics. Mg is preferably added in the range of 0.1-3.0% by mole, based on the total amount of metal elements, other than lithium, present in lithium cobaltate. Zr is preferably present in the form of particles adhering to a surface of lithium cobaltate.

The use of a copper or copper alloy foil for the current collector in the present invention is particularly preferred. The copper alloy is not particularly specified, so long as it contains copper. Examples of copper alloys include Cu—Ag, Cu—Te, Cu—Mg, Cu—Sn, Su-Si, Cu—Mn, Cu—Be—Co, Cu—Ti, Cu—Ni—Si, Cu—Cr, Cu—Zr, Cu—Fe, Cu—Al, Cu—Zn and Cu—Co alloys.

Examples of nonaqueous electrolyte solutes useful in the present invention include LiPF₆, LiBF₄, LiCF₃SO₃, LiN(CF₃SO₂)₂, LiN(C₂F₅SO₂)₂, LiN(CF₃SO₂)(C₄F₉SO₂), LiC(CF₃SO₂)₃, LiC(C₂F₅SO₂)₃, LiAsF₆, LiClO₄, Li₂B₁₀Cl₁₀, Li₂B₁₂C₁₂ and mixtures thereof.

In accordance with the present invention, a nonaqueous electrolyte secondary battery can be obtained which includes a positive electrode, a negative electrode and a separator arranged in a stack and wound in a cylindrical configuration and which exhibits a high energy density and superior cycle characteristics.

### BRIEF DESCRIPTION OF THE DRAWINGS

FIG. 1 is a perspective view which shows the electrode assembly used in the cylindrical battery in accordance with the present invention; and

FIG. 2 is a perspective view which shows the electrode assembly used in the flat battery for comparative purpose.

### DESCRIPTION OF THE PREFERRED EXAMPLES

The present invention is below described in more detail by way of Examples. It will be recognized that the following examples merely illustrate the present invention and are not intended to be limiting thereof. Suitable changes can be effected without departing from the scope of the present invention.

### (Construction of Cylindrical Batteries: Example 1 and Comparative Examples 1-4)

(Fabrication of Positive Electrode)

A lithium cobalt complex oxide (mean particle diameter of 13 μm, BET specific surface area of 0.35 m²/g), represented by LiCoO₂ and incorporating zirconium in the form of particles adhering to its surface, was used as a positive active material. This positive active material was obtained by mixing Li₂CO₃, CO₃O₄ and ZrO₂ in an Ishikawa automated mortar, heating the mixture in the ambient atmosphere at 850° C. for 24 hours and then pulverizing the mixture.

The above-prepared particles of positive active material, a carbon material powder as a positive electrical conductor and polyvinylidene fluoride as a positive binder, in the 94:3:3 ratio by weight of active material to conductor to binder, were added to N-methyl-2-pyrrolidone as a dispersing medium. The resulting mixture was then kneaded to prepare a cathode mix slurry.

This cathode mix slurry was coated on opposite sides of a 15 μm thick, 522 mm long and 34 mm wide aluminum foil as a current collector such that a 482 mm×34 mm coat was applied to a top side and a 497 mm×34 mm coat to a bottom side, dried and then calendered to provide an electrode having a thickness of 117 μm. The amount of the cathode mix layer on the current collector was 38 mg/cm² and its packing density was 3.73 g/cm³.

A 70 μm thick, 35 mm long and 4 mm wide aluminum flat plate as a current collector tab was attached to a portion of the current collector that was left uncoated with the cathode mix slurry by a calking method to complete fabrication of a positive electrode.

(Fabrication of Negative Electrode)

A silicon powder (99.9% pure) having a mean particle diameter of 10 μm as a negative active material, a graphite powder as an electrical conductor and thermoplastic polyimide (glass transition temperature of 190° C., density of 1.1 g/cm³) as a negative binder, in the 87:3:7.5 ratio by weight of active material to conductor to binder, were mixed in N-methyl-2-pyrrolidone as a dispersing medium to prepare an anode mix slurry.

This anode mix slurry was coated on opposite sides of a Cu—Ni—Si—Mg (Ni: 3% by weight, Si: 0.65% by weight, Mg: 0.15% by weight) alloy foil (surface roughness Ra of 0.33 μm, thickness of 20 μm) and then dried. The amount of the anode mix layer on the current collector was 5.6 mg/cm².

A 535 mm×36 mm rectangular piece was cut out from the resultant, calendered and heat treated under argon atmosphere at 400° C. for 10 hours to accomplish sintering. The calendered piece was 62 μm thick. A 70 μm thick, 35 mm long and 4 mm wide, flat nickel plate as a current collector tab was attached to an end of the piece to complete a negative electrode.

(Fabrication of Electrode Assembly)

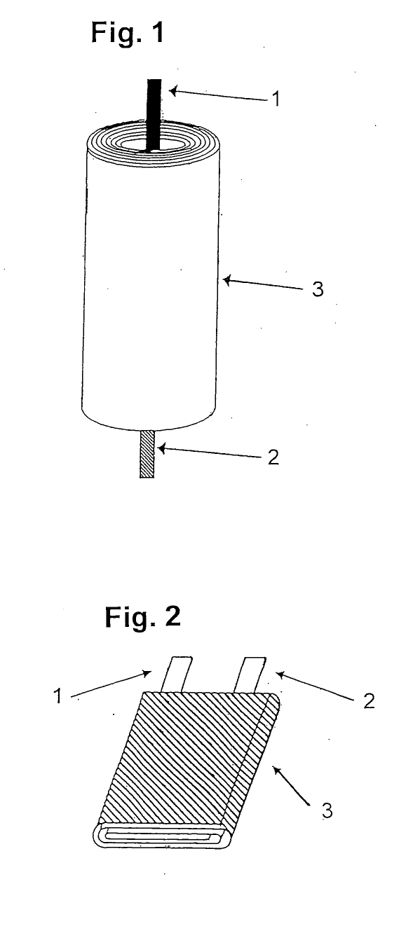

The above negative electrode, positive electrode and separator (20 μm thick porous structure of polyethylene) were used to fabricate a lithium secondary battery. The separator was interposed between the positive electrode and the negative electrode to form a stack which was subsequently spirally wound with the negative electrode inside to fabricate an electrode assembly shown in FIG. 1.

As shown in FIG. 1, the electrode assembly 3 includes a positive current collector tab attached to an end portion of the positive electrode, and a negative electrode collector tab 2 attached to an end portion of the negative electrode.

This spirally-wound electrode assembly was inserted in an outer casing made of a laminate material such as a of PET or aluminum. One end of the outer casing was sealed such that a leading end of each current collector tab extended outwardly from the one end. The other end of the outer casing was left open.

(Preparation of Electrolyte)

4-fluoro-1,3-dioxolane-2-one (FEC), methyl propionate (MP), ethylene carbonate (EC), propylene carbonate (PC), diethyl carbonate (DEC), methylethyl carbonate (MEC) and dimethyl carbonate (DMC) were mixed in the ratio specified in Table 1. 1.0 mol/liter of LiPF₆ as a solute was added to each mixed solvent to prepare electrolytes No. 1-No. 5.

TABLE 1

| Electrolyte | Solute | Solvent (vol. %) | | | | | | |
|---|---|---|---|---|---|---|---|---|
| Type | LiPF₆ | FEC | EC | PC | MP | DEC | MEC | DMC |
| 1 | 1.0M | 20 | — | — | 80 | — | — | — |
| 2 | | 10 | 27 | — | — | 63 | — | — |
| 3 | | 10 | 10 | 10 | — | 30 | 40 | — |
| 4 | | 10 | 20 | — | — | — | 5 | 65 |
| 5 | | 20 | — | 5 | — | — | 30 | 45 |

(Construction of Battery)

5 ml of each of the electrolytes No. 1-No. 5 was poured into a respective outer casing, through its open end, which enclosed the spirally-wound electrode assembly in the fashion described above. Thereafter, the open end was heat sealed to construct a cylindrical battery.

### (Construction of Flat Batteries: Comparative Examples 5-9)

(Fabrication of Positive Electrode)

A cathode mix slurry was prepared in the same manner as in the above Example and Comparative Examples in Construction of Cylindrical Batteries.

This cathode mix slurry was coated on opposite sides of an aluminum foil (15 μm thick, 402 mm long and 50 mm wide) as a positive current collector such that a 340 mm×50 mm coat was applied to a top side and a 271 mm×50 mm coat to a bottom side, dried and then rolled or calendered. After calendered, a positive electrode was 117 μm thick. The amount of the cathode mix layer on the current collector was 38 mg/cm² and its packing density was 3.73 g/cm³

A 70 μm thick, 35 mm long and 4 mm wide aluminum flat plate as a current collector tab was attached by ultrasonic welding to a portion of the current collector that was left uncoated with the cathode mix slurry to complete the positive electrode.

(Fabrication of Negative Electrode)

An anode mix slurry was prepared in the same manner as in the above Example and Comparative Examples in Construction of Cylindrical Batteries.

This anode mix slurry was coated on opposite sides of a Cu—Ni—Si—Mg (Ni: 3% by weight, Si: 0.65% by weight, Mg: 0.15% by weight) alloy foil (surface roughness Ra of 0.3 μm, thickness of 20 μm) and then dried. The amount of the anode mix layer on the current collector was 5.6 mg/cm².

A 380 mm×52 mm rectangular piece was cut out from the resultant, rolled or calendered and then heat treated under argon atmosphere at 400° C. for 10 hours to accomplish sintering. After calendered, a negative electrode was 62 μm thick. A 70 μm thick, 35 mm long and 4 mm wide, flat nickel plate as a current collector tab was attached to an end of the negative electrode to complete the negative electrode.

(Fabrication of Electrode Assembly)

The preceding negative electrode and positive electrode, and two sheets of separators each comprising a polyethylene porous structure (20 μm thick, 430 mm long and 54.5 mm wide) were used. The positive electrode and the negative electrode were assembled in a sandwich configuration with the separators between them and then folded along predetermined locations to fabricate an electrode assembly shown in FIG. 2.

As shown in FIG. 2, the electrode assembly 3 was wound such that a positive current collector tab 1 and a negative current collector tab 2 were located in an outermost fold.

This flattened spirally-wound electrode assembly was inserted in an outer casing made of a laminate material such as a of PET or aluminum. One end of the outer casing was sealed such that a leading end of each current collector tab extended outwardly from the one end. The other end of the outer casing was left open.

(Preparation of Electrolyte)

The electrolytes No. 1-No. 5 specified in Table 1 were prepared in the same manner as in Construction of Cylindrical Batteries.

(Construction of Battery)

5 ml of each of the electrolytes No. 1-No. 5 was poured into a respective outer casing, through its open end, which enclosed the spirally-wound electrode assembly in the fashion described above. Thereafter, the open end was heat sealed to construct a flat battery.

(Charge-Discharge Test on Cylindrical Batteries (Example 1 and Comparative Examples 1-4))

The cylindrical batteries (Example 1 and Comparative Examples 1-4) constructed in the above-described manner were subjected to a charge-discharge test. Each battery at 25° C. was charged at a current of 180 mA to 4.2 V, successively charged to a current of 45 mA while maintained at 4.2V, and then discharged at a current of 180 mA to 2.75 V. This was recorded as a unit cycle of charge and discharge.

Next, in a room-temperature environment, constant-current and constant-voltage charging at 900 mA was performed to an upper voltage limit of 4.2 V and then constant-current discharging at 900 mA was performed to a lower voltage limit of 2.75 V. Charge-discharge cycling under the same charge-discharge conditions was repeated 300 times. A capacity retention (%) of the battery in the 300^{th} cycle when its first-cycle discharge capacity was taken as 100 was determined and recorded as a cycle life.

A cycle life (discharge capacity retention after 300 cycles) of each battery is shown in Table 2. In Table 2, the cycle life is given by an index when that of the battery of Example 1 is taken as 100. Table 2 also lists a viscosity of the electrolyte used in each battery. This viscosity was measured at normal (room) temperature.

TABLE 2

| | Battery | | Viscosity | Cycle |
|---|---|---|---|---|
| | Construction | Electrolyte | (mPas) | Life |
| Example 1 | Cylindrical | 1 | 1.6 | 100 |
| Comparative Example 1 | | 2 | 3.5 | 17 |
| Comparative Example 2 | | 3 | 3.2 | 25 |
| Comparative Example 3 | | 4 | 2.7 | 33 |
| Comparative Example 4 | | 5 | 2.9 | 42 |

As can be clearly seen from Table 2, the battery of Example 1 using the electrolyte that contains a mixed solvent of FEC and MP and has a viscosity of not higher than 2.5 mPas, i.e., a viscosity of 1.6 mPas, shows good charge-discharge cycle characteristics. In contrast, the batteries of Comparative Examples 1-4 using the electrolytes having viscosities of higher than 2.5 mPas fail to provide good charge-discharge cycle characteristics.

(Charge-Discharge Test on Flat Batteries (Comparative Examples 5-9))

The flat batteries (Comparative Examples 5-9) fabricated in the above-described fashion were subjected to a charge-discharge test. Each battery at 25° C. was charged at a current of 160 mA to 4.2 V, successively charged to a current of 40 mA while maintained at 4.2 V, and then discharged at a current of 160 mA to 2.75 V. This was recorded as a unit cycle of charge and discharge.

Next, in a room-temperature environment, constant-current and constant-voltage charging at 800 mA was performed to an upper voltage limit of 4.2 V and then constant-current discharging at 800 mA was performed to a lower voltage limit of 2.75 V. Charge-discharge cycling under the same charge-discharge conditions was repeated 300 times. A capacity retention (%) of the battery in the 300^{th} cycle when its first-cycle discharge capacity was taken as 100 was determined and recorded as a cycle life.

A cycle life of each battery is shown in Table 3. In Table 3, the cycle life is given by an index when that of the battery of Comparative Example 5 is taken as 100. Table 3 also lists a viscosity of the electrolyte used in each battery.

TABLE 3

| | Battery | | Viscosity | Cycle |
|---|---|---|---|---|
| | Construction | Electrolyte | (mPas) | Life |
| Comparative Example 5 | Flat | 1 | 1.6 | 100 |
| Comparative Example 6 | | 2 | 3.5 | 140 |
| Comparative Example 7 | | 3 | 3.2 | 130 |
| Comparative Example 8 | | 4 | 2.7 | 130 |
| Comparative Example 9 | | 5 | 2.9 | 122 |

As shown in Table 3, in the case of flat batteries, the battery of Comparative Example 5 using the electrolyte with a viscosity of not higher than 2.5 mPas rather shows poorer charge-discharge cycle characteristics than the others, as contrary to the case of cylindrical batteries. This is believed due to the electrochemical stability of the electrolyte used. That is, the reason for the deterioration of the flat battery in cycle characteristics when the electrolyte thereof contains a chain carboxylate ester, MP, is believed due to the initiation of a side reaction in the vicinity of the electrode by MP that is lower in electrochemical stability than a chain carbonate.

On the other hand, the cylindrical battery experiences a rapid deleterious change during charge-discharge cycles and shows deterioration in charge-discharge characteristics when the electrolyte thereof contains a solvent which is considered high in electrochemical stability.

In Example 1, MP is used as a base solvent. Because the viscosity of MP is 0.43 mPas and is about two-thirds of that of DMC, an electrolyte can be obtained having such a low density that a chain carbonate can not provide. The use of such a low-density electrolyte is believed to ease another penetration of the electrolyte into an interior of the electrode assembly expanded by charges and discharges and accordingly reduce the tendency of a charge-discharge reaction toward heterogeneity.

Such a difference between the cylindrical battery and the flat battery is believed to result from the above-discussed electrolyte depletion in the electrode assembly that exerts a much greater effect on the cylindrical battery than on the flat battery and seemingly overrides the effect of electrochemical stability of the solvent in the cylindrical battery.

Also, the inclusion of FEC in the electrolyte has been found successful in preventing degradation of a silicon alloy or other alloy negative electrode and further improving cycle characteristics.

(Construction of Cylindrical Batteries: Example 2 and Comparative Examples 10-13)

(Fabrication of Positive Electrode)

A powder of the same positive active material as used in the preceding Example and Comparative Examples, a carbon material powder as a positive electrical conductor and polyvinylidene fluoride as a positive binder, in the 94:3:3 ratio by weight of active material to conductor to binder, were added to N-methyl-2-pyrrolidone as a dispersing medium. The resulting mixture was then kneaded to prepare a cathode mix slurry.

This cathode mix slurry was coated on opposite sides of a 15 μm thick, 522 mm long and 34 mm wide aluminum foil as a positive current collector such that a 471 mm×34 mm coat was applied to a top side and a 481 mm×34 mm coat to a bottom side, dried and then calendered to provide an electrode having a thickness of 130 μm. The amount of the cathode mix layer on the current collector was 43 mg/cm² and its packing density was 3.74 g/cm³.

A 70 μm thick, 35 mm long and 4 mm wide aluminum flat plate as a current collector tab was attached to a portion of the current collector that was left uncoated with the cathode mix slurry to complete fabrication of a positive electrode.

(Fabrication of Negative Electrode)

The same current collector as in the preceding Example 1 was used as a negative current collector. A silicon thin film was deposited on each side of the current collector. More specifically, the silicon thin film was deposited on each side of the current collector by an electron beam deposition method wherein irradiation was carried out using an argon (Ar) ion beam at a pressure of 0.05 Pa at a current density of 0.27 mA/cm² and a single crystal silicon was used as a material to be deposited.

Subsequent to deposition of the silicon thin films, a section of the current collector was observed with SEM to measure a thickness of each film. Measurement revealed the thickness of the silicon thin film deposited on each side of the current collector as being about 15 μm thick. Also, the Raman spectroscopy detected the presence of a peak around 480 cm⁻¹ and the absence of a peak around 520 cm⁻¹. From this analysis, the deposited thin film was confirmed as the amorphous silicon thin film.

A 524 mm×36 mm rectangular piece was cut out from the current collector with the thin films deposited thereon. A 70 μm thick, 35 mm long and 4 mm wide, flat nickel plate as a current collector tab was attached to the piece by a calking method to complete a negative electrode.

(Fabrication of Electrode Assembly)

The above-fabricated positive electrode and negative electrode were used. Otherwise, the procedure of Example 1 was followed to fabricate an electrode assembly.

(Preparation of Electrolytes)

The electrolytes listed in Table 1 were prepared according to the same procedure as in the fabrication of cylindrical batteries (Example 1 and Comparative Examples 1-4).

(Construction of Batteries)

Cylindrical batteries were constructed in the same manner as in the preceding Example 1 and Comparative Examples 1-4.

(Charge-Discharge Test on Cylindrical Batteries (Example 2 and Comparative Examples 10-13))

The cylindrical batteries (Example 2 and Comparative Examples 10-13) constructed in the above-described manner were subjected to a charge-discharge test. Each battery at 25° C. was charged at a current of 180 mA to 4.2 V, successively charged to a current of 45 mA while maintained at 4.2 V, and then discharged at a current of 180 mA to 2.75 V. This was recorded as a unit cycle of charge and discharge.

Next, in a room-temperature environment, constant-current and constant-voltage charging at 900 mA was performed to an upper voltage limit of 4.2 V and then constant-current discharging at 900 mA was performed to a lower voltage limit of 2.75 V. Charge-discharge cycling under the same charge-discharge conditions was repeated 300 times. A capacity retention (%) of the battery in the 300^{th} cycle when its first-cycle discharge capacity was taken as 100 was determined and recorded as a cycle life.

A cycle life of each battery is shown in Table 4. In Table 4, the cycle life is given by an index when that of the battery of Example 2 is taken as 100. Table 4 also lists a viscosity of the electrolyte used in each battery. This viscosity was measured at normal (room) temperature.

TABLE 4

| | Battery | | Viscosity | Cycle |
|---|---|---|---|---|
| | Construction | Electrolyte | (mPas) | Life |
| Example 2 | Cylindrical | 1 | 1.6 | 100 |
| Comparative Example 10 | | 2 | 3.5 | 10 |
| Comparative Example 11 | | 3 | 3.2 | 19 |
| Comparative Example 12 | | 4 | 2.7 | 32 |
| Comparative Example 13 | | 5 | 2.9 | 24 |

As shown in Table 4, the battery of Example 2 using the electrolyte that contains a mixed solvent of FEC and MP and has a viscosity of not higher than 2.5 mPas, i.e., a viscosity of 1.6 mPas, shows good charge-discharge cycle characteristics. In contrast, the batteries of Comparative Examples 10-13 using the electrolytes having viscosities of higher than 2.5 mPas experienced rapid deleterious change during charge-discharge cycles and, after 300 charge-discharge cycles, merely exhibited less than a half of the discharge capacity of the battery of Example 2.

Such behaviors of those batteries are believed due to the expansion of the negative electrode during a charge-discharge reaction that allows the electrolyte once retained in the electrode assembly to exit therefrom, renders the charge-discharge reaction heterogeneous and accordingly causes rapid deterioration of cycle characteristics, as similar to the case of the battery using the silicon powder negative electrode. The inclusion of the fluorinated cyclic carbonate and the chain carboxylate ester that is lower in viscosity than conventional chain carbonates, in accordance with the present invention, eases another penetration of the electrolyte into the electrode assembly, even after the electrolyte was released from the electrode assembly, and improves cycle characteristics of the cylindrical battery using the alloy negative electrode.

(Relation Between MP Content and Viscosity of Electrolyte)

When a blending proportion of FEC and MP in an electrolyte containing 1.0 mol/liter LiPF₆ dissolved therein was varied, the electrolyte at normal temperature exhibited the viscosity specified in Table 5. Table 5 also shows the viscosity of the electrolyte which contains DMC or EMC instead of MP.

TABLE 5

| Electrolyte | Viscosity (mPas) |
|---|---|
| 1.0M LiPF₆ FEC/MP = 5/95 | 1.2 |
| 1.0M LiPF₆ FEC/MP = 10/90 | 1.3 |
| 1.0M LiPF₆ FEC/MP = 20/80 | 1.6 |
| 1.0M LiPF₆ FEC/MP = 30/70 | 1.9 |
| 1.0M LiPF₆ FEC/MP = 40/60 | 2.3 |
| 1.0M LiPF₆ FEC/MP = 50/50 | 2.9 |
| 1.0M LiPF₆ FEC/DMC = 20/80 | 2.1 |
| 1.0M LiPF₆ FEC/EMC = 20/80 | 2.5 |

As can be seen from Table 5, the density of the electrolyte can be adjusted by varying a blending proportion of MP and FEC. Also, significantly reduced electrolyte viscosity is obtained by incorporating MP relative to incorporating a conventional chain carbonate, DMC or EMC.

(Construction of Cylindrical Batteries: Examples 3-8 and Comparative Examples 14 and 15)

(Fabrication of Positive Electrode)

A positive electrode was fabricated in the same manner as in the preceding Example 1.

(Fabrication of Negative Electrode)

A negative electrode was fabricated in the same manner as in the preceding Example 1.

(Fabrication of Electrode Assembly)

An electrode assembly was fabricated in the same manner as in the preceding Example 1.

(Preparation of Electrolytes)

The procedure of Example 1 was followed to prepare the electrolytes specified in the following Table 6. Table 6 also shows the electrolytes specified in Table 1.

TABLE 6

| | | Solvent (vol. %) | | | | | | | |
|---|---|---|---|---|---|---|---|---|---|
| Elec- | | | DFEC | | | | | | |
| trolyte | Solute | | (Trans | | | | | | |
| Type | LiPF₆ | FEC | Form) | EC | PC | MP | DEC | MEC | DMC |
| 1 | 1.0M | 20 | — | — | — | 80 | — | — | — |
| 2 | | 10 | — | 27 | — | — | 63 | — | — |
| 3 | | 10 | — | 10 | 10 | — | 30 | 40 | — |
| 4 | | 10 | — | 20 | — | — | — | 5 | 65 |
| 5 | | 20 | — | — | 5 | — | — | 30 | 45 |
| 6 | | — | — | 20 | — | 80 | — | — | — |
| 7 | | — | 20 | — | — | 80 | — | — | — |
| 8 | | 18 | 2 | — | — | 80 | — | — | — |
| 9 | | 15 | 5 | — | — | 80 | — | — | — |
| 10 | | 10 | 10 | — | — | 80 | — | — | — |
| 11 | | 10 | — | — | — | 90 | — | — | — |
| 12 | | 30 | — | — | — | 70 | — | — | — |
| 13 | | 50 | — | — | — | 50 | — | — | — |

(Construction of Batteries)

Cylindrical batteries were constructed in the same manner as in the preceding Example 1.

(Charge-Discharge Test on Cylindrical Batteries (Examples 3-8 and Comparative Examples 14 and 15))

The cylindrical batteries (Examples 3-8 and Comparative Examples 14 and 15) constructed in the above-described fashion were subjected to a charge-discharge test. Each battery at 25° C. was charged at a current of 180 mA to 4.2 V, successively charged to a current of 45 mA while maintained at 4.2V, and then discharged at a current of 180 mA to 2.7 V. This was recorded as a unit cycle of charge and discharge.

Next, in a room-temperature environment, constant-current and constant-voltage charging at 900 mA was performed to an upper voltage limit of 4.2 V and then constant-current discharging at 900 mA was performed to a lower voltage limit of 2.75 V. Charge-discharge cycling under the same charge-discharge conditions was repeated 300 times. A capacity retention (%) of the battery in the 300^{th} cycle when its first-cycle discharge capacity was taken as 100 was determined and recorded as a cycle life.

Respective cycle lives of the batteries of Examples 3-8 and Comparative Examples 14 and 15 are shown in Table 7. Table 7 also shows the cycle lives listed in Table 2 for the batteries of Example 1 and Comparative Examples 1-4. In Table 7, the cycle life is given by an index when that of the battery of Example 1 is taken as 100. Table 7 also shows a viscosity of the electrolyte used in each battery. This viscosity was measured at normal (room) temperature.

TABLE 7

| | Battery | | Viscosity | Cycle |
|---|---|---|---|---|
| | Construction | Electrolyte | (mPas) | Life |
| Example 1 | Cylindrical | 1 | 1.6 | 100 |
| Example 3 | | 7 | 1.6 | 114 |
| Example 4 | | 8 | 1.6 | 107 |
| Example 5 | | 9 | 1.6 | 113 |
| Example 6 | | 10 | 1.6 | 113 |
| Example 7 | | 11 | 1.3 | 102 |
| Example 8 | | 12 | 1.9 | 97 |
| Comparative Example 1 | | 2 | 3.5 | 17 |
| Comparative Example 2 | | 3 | 3.2 | 25 |
| Comparative Example 3 | | 4 | 2.7 | 33 |
| Comparative Example 4 | | 5 | 2.9 | 42 |
| Comparative Example 14 | | 6 | 1.6 | 6 |
| Comparative Example 15 | | 13 | 2.9 | 40 |

As shown in Table 7, the electrolyte of Comparative Example 14 showed a low viscosity of 1.6 mPas, which value is equal to that of the electrolyte of Example 1, but the battery of Comparative Example 14 exhibits a very short cycle life of 6. This is believed due to the absence of a fluorinated cyclic carbonate in the solvent used in the battery of Comparative Example 14. These results have demonstrated that, if superior cycle characteristics are to be obtained, it is required that the solvent not only have a viscosity of not higher than 2.5 mPas but also contain a fluorinated cyclic carbonate to thereby suppress decomposition of the solvent in the electrolyte during discharges and charges and prevent release of the electrolyte from the electrode assembly.

As shown in Table 7, the battery of Example 3 which uses the solvent containing trans-4,5-difluoro-1,3-dioxolane-2-one (DFEC) as the fluorinated cyclic carbonate exhibits a cycle performance that is about comparable to that of the battery of Example 1 which uses the solvent containing 4-fluoro-1,3-dioxolane-2-one (FEC) as the fluorinated cyclic carbonate. This result has demonstrated that a high cycle performance can be obtained even in the case where the solvent contains DFEC as the sole fluorinated cyclic carbonate.

Improved cycle performance relative to the battery of Example 1 which uses the solvent containing FEC as the sole fluorinated cyclic carbonate is obtained for the batteries of Examples 4-6 which use the solvent containing FEC and DFEC as the fluorinated cyclic carbonate. As can be appreciated from this result, a cycle performance can be further improved when the solvent contains FEC and DFEC as the fluorinated cyclic carbonate than when the solvent contains FEC as the sole fluorinated cyclic carbonate. This is most probably because the inclusion of DFEC, which is more susceptible to reduction than FEC, in the solvent results in the formation of a denser film on a surface of the negative electrode. Also, DFEC having two fluorine atoms in the compound is considered superior in acid resistance to FEC. It is therefore believed that a portion of DFEC that was left unreduced in the negative electrode side after the occurrence of polarization during a charge-discharge reaction suppressed decomposition of the electrolyte in the positive electrode side and accordingly improved a cycle performance.

Also in the Examples 4-6, a trans-form DFEC is used which is more effective than cis-form DFEC in lowering a viscosity of the electrolyte and suppressing release of the electrolyte from the electrode assembly. Accordingly, the use of the trans-form DFEC is believed to have contributed to the higher cycle performance.

As can be appreciated from the results shown in Table 7 for the batteries of Examples 1, 7 and 8 and Comparative Example 15, the electrolyte of Example 7 having the lowest FEC content of 10% has the lowest viscosity. The electrolyte viscosity increases with the FEC content. It has been also found that a cycle performance tends to deteriorate with an increasing viscosity. A 97% or higher cycle performance was obtained for the electrolytes of Examples 1, 7 and 8 which were relatively low in FEC content and had viscosities of not higher than 2.5 mPas. In contrast, only a low cycle performance of 40% was obtained for the electrolyte of Comparative Example 15 which was high in FEC content and had a viscosity of higher than 2.5 mPas. As can also be appreciated from these results, the improved cycle performance is obtained if the electrolyte viscosity is controlled not to exceed 2.5 mPas.

### (Construction of Cylindrical Batteries: Example 9 and Comparative Example 16)

(Fabrication of Positive Electrode)

A lithium cobalt complex oxide (mean particle diameter of 13 μm, BET specific surface area of 0.35 m²/g), represented by LiCoO₂ and incorporating zirconium in the form of particles adhering to its surface, was used as a positive active material. A powder of the positive active material, a carbon material powder as a positive electrical conductor and polyvinylidene fluoride as a positive binder, in the 94:3:3 ratio by weight of active material to conductor to binder, were added to N-methyl-2-pyrrolidone as a dispersing medium and the kneaded to provide a cathode mix slurry.

This cathode mix slurry was coated on opposite sides of a 15 μm thick, 495 mm long and 34 mm wide aluminum foil as a positive current collector such that a 465 mm×34 mm coat was applied to a top side and a 465 mm×34 mm coat to a bottom side, dried and then calendered to provide an electrode having a thickness of 127 μm. The amount of the cathode mix layer on the current collector was 38 mg/cm². A 70 μm thick, 35 mm long and 4 mm wide aluminum flat plate as a current collector tab was attached to a portion of the current collector that was left uncoated with the cathode mix slurry to complete fabrication of a positive electrode.

(Fabrication of Negative Electrode)

A negative electrode was fabricated in the same manner as in the preceding Example 1.

(Fabrication of Electrode Assembly)

An electrode assembly was fabricated in the same manner as in the preceding Example 1.

(Preparation of Electrolyte)

The electrolytes specified in Table 1 were prepared in the same manner as in Construction of Cylindrical Batteries (Example 1 and Comparative Examples 1-4).

(Construction of Batteries)

Cylindrical batteries were constructed in the same manner as in the preceding Example 1.

(Charge-Discharge Test on Cylindrical Batteries (Example 9 and Comparative Example 16))

The cylindrical batteries (Example 1 and Comparative Example 16) constructed in the above-described manner were subjected to a charge-discharge test. Each battery at 25° C. was charged at a current of 180 mA to 4.2 V, successively charged to a current of 45 mA while maintained at 4.2V, and then discharged at a current of 180 mA to 2.75 V. This was recorded as a unit cycle of charge and discharge.

Next, in a room-temperature environment, constant-current and constant-voltage charging at 900 mA was performed to an upper voltage limit of 4.2 V and then constant-current discharging at 900 mA was performed to a lower voltage limit of 2.75 V. Charge-discharge cycling under the same charge-discharge conditions was repeated 300 times. A capacity retention (%) of the battery in the 300^{th} cycle when its first-cycle discharge capacity was taken as 100 was determined and recorded as a cycle life.

Respective cycle lives of the batteries of Example 9 and Comparative Example 16, as well as the cycle lives also shown in Table 2 for the batteries of Example 1 and Comparative Example 4, are listed in Table 8. The cycle lives shown in Table 8 for the batteries of Example 1 and Comparative Example 4 are given by index numbers when that of the battery of Example 1 is taken as 100. The cycle lives shown in Table 8 for the batteries of Example 9 and Comparative Example 16 are given by index numbers when that of the battery of Example 9 is taken as 100. Table 8 also shows a viscosity of each electrolyte and a packing density (positive electrode packing density) of each positive active material. The viscosity values are measurements at normal (room) temperature.

TABLE 8

| | | | | Positive | |
|---|---|---|---|---|---|
| | | | | Electrode | |
| | | | | Packing | |
| | Battery | | Viscosity | Density | Cycle |
| | Construction | Electrolyte | (mPas) | (g/cm³) | Life |
| Example 1 | Cylindrical | 1 | 1.6 | 3.73 | 100 |
| Comparative | | 5 | 2.9 | 3.73 | 42 |
| Example 4 | | | | | |
| Example 9 | Cylindrical | 1 | 1.6 | 3.4 | 100 |
| Comparative | | 5 | 2.9 | 3.4 | 91 |
| Example 16 | | | | | |

As can be appreciated from comparison between Example 1 and Comparative Example 4 in which a packing density of the positive active material was controlled not to fall below 3.7 g/cm³, the cycle life was greatly improved from 42 to 100 by decreasing the electrolyte viscosity from 2.9 mPas to 1.6 mPas. By contrary, in comparison between Example 9 and Comparative Example 16 in which a packing density of the positive active material was controlled to fall below 3.7 g/cm³, the cycle life only improved from 91 to 100 even if the electrolyte viscosity was decreased from 2.9 mPas to 1.6 mPas. That is, it has been found that if the positive electrode packing density has a low value of below 3.7 g/cm³, the decrease of electrolyte density does not lead to a marked improvement of a cycle life.

Because the amount of the electrode active material in the battery decreases with the packing density of the positive active material, an energy density of the battery tends to decrease with the packing density of the positive active material. Accordingly, the packing density of the positive active material is preferably rendered higher in order to increase the energy density of the battery. Therefore, it is particularly preferred that the positive electrode packing density is rendered not to fall below 3.7 g/cm³ and, at the same time, the electrolyte viscosity is rendered not to exceed 2.5 mPas, such as in Example 1. This results in obtaining a battery which exhibits high energy density and cycle performance.

1. A nonaqueous electrolyte secondary battery including a positive electrode containing a positive active material, a negative electrode containing a negative active material, a separator interposed between said positive electrode and said negative electrode and a nonaqueous electrolyte containing a solvent and a solute, and said positive electrode, said negative electrode and said separator being stacked and wound in a cylindrical configuration,
wherein said negative active material comprises a material capable of storing lithium by alloying with lithium, said solvent in said nonaqueous electrolyte contains a fluorinated cyclic carbonate, and said nonaqueous electrolyte has a viscosity of not higher than 2.5 mPas.

2. The nonaqueous electrolyte secondary battery as recited in claim 1, wherein said solvent in said nonaqueous electrolyte contains a chain carboxylate ester represented by R₁COOR₂ (R₁ and R₂ are independently an alkyl group having a carbon number of 3 or less).

3. The nonaqueous electrolyte secondary battery as recited in claim 2, wherein said chain carboxylate ester content is 70% by volume or more, based on the total amount of the solvent.

4. The nonaqueous electrolyte secondary battery as recited in claim 2, wherein said chain carboxylate ester is methyl propionate.

5. The nonaqueous electrolyte secondary battery as recited in claim 1, wherein said fluorinated cyclic carbonate contains at least one of 4-fluoro-1,3-dioxolane-2-one and 4,5-difluoro-1,3-dioxolane-2-one.

6. The nonaqueous electrolyte secondary battery as recited in claim 1, wherein said fluorinated cyclic carbonate contains both of 4-fluoro-1,3-dioxolane-2-one and 4,5-difluoro-1,3-dioxolane-2-one.

7. The nonaqueous electrolyte secondary battery as recited in claim 5, wherein said 4,5-difluoro-1,3-dioxolane-2-one is in the trans form.

8. The nonaqueous electrolyte secondary battery as recited in claim 1, wherein said negative active material is a silicon-containing material.

9. The nonaqueous electrolyte secondary battery as recited in claim 1, wherein said negative electrode includes a current collector comprising an electrically conductive copper alloy foil having a roughened surface.

10. The nonaqueous electrolyte secondary battery as recited in claim 1, wherein said negative electrode is obtained by depositing a thin film of an active material containing a silicon and/or silicon ally on a current collector.

11. The nonaqueous electrolyte secondary battery as recited in claim 10, wherein said active material thin film is deposited by a CVD, sputtering, vapor deposition, melt spraying or plating process.

12. The nonaqueous electrolyte secondary battery as recited in claim 1, wherein said negative electrode is obtained by sintering, under the non-oxidizing atmosphere, an anode mix layer containing a binder and a particulate active material containing a silicon and/or silicon alloy on a surface of a current collector.

13. The nonaqueous electrolyte secondary battery as recited in claim 12, wherein said sintering is carried out at a temperature that is not lower than a melting point or glass transition temperature of said binder.

14. The nonaqueous electrolyte secondary battery as recited in claim 1, wherein said positive active material comprises lithium cobaltate, and a positive active material layer provided on a current collector and containing a binder and an electrical conductor has a packing density of at least 3.7 g/cm³.

15. The nonaqueous electrolyte secondary battery as recited in claim 2, wherein said fluorinated cyclic carbonate contains at least one of 4-fluoro-1,3-dioxolane-2-one and 4,5-difluoro-1,3-dioxolane-2-one.

16. The nonaqueous electrolyte secondary battery as recited in claim 2, wherein said fluorinated cyclic carbonate contains both of 4-fluoro-1,3-dioxolane-2-one and 4,5-difluoro-1,3-dioxolane-2-one.

17. The nonaqueous electrolyte secondary battery as recited in claim 3, wherein said fluorinated cyclic carbonate contains at least one of 4-fluoro-1,3-dioxolane-2-one and 4,5-difluoro-1,3-dioxolane-2-one.

18. The nonaqueous electrolyte secondary battery as recited in claim 3, wherein said fluorinated cyclic carbonate contains both of 4-fluoro-1,3-dioxolane-2-one and 4,5-difluoro-1,3-dioxolane-2-one.
